(19) United States
(12) Patent Application Publication
(10) Pub. No.: US 2026/0264671 A1
(43) Pub. Date: Sep. 10, 2026

(54) VEHICLE CONTROL DEVICE, VEHICLE CONTROL METHOD, AND NON-TRANSITORY STORAGE MEDIUM

(71) Applicant: HONDA MOTOR CO., LTD., Tokyo (JP)

(72) Inventors: Kensuke Arai, Tokyo (JP); Takuya Niioka, Tokyo (JP); Yusuke Ogata, Tokyo (JP)

(21) Appl. No.: 19/543,890

(22) Filed: Feb. 19, 2026

(30) Foreign Application Priority Data
Mar. 5, 2025 (JP) 2025-034388

(51) Int. Cl. B60W 30/09; B60W 30/095; B60W 30/14; G01S 15/931; G06V 20/58

(52) U.S. Cl. CPC B60W 30/09; B60W 30/0956; B60W 30/146; G01S 15/931; G06V 20/58; B60W 2420/403; B60W 2420/54; B60W 2554/802; B60W 2556/35

(57) ABSTRACT

A vehicle control device recognizes an object near a vehicle on the basis of surroundings information indicating a surrounding situation of the vehicle , the surrounding situation being provided by a detection device to detect the surrounding situation at intervals of a predetermined detection period, performs deceleration control for decelerating the vehicle with respect to the object when a degree of approach between the vehicle and the object satisfies predetermined conditions on the basis of a result of the recognition , and continuously performs the deceleration control even when the object is not temporarily detected by the detection device and the object is not recognized while performing the deceleration control.

### CROSS-REFERENCE TO RELATED APPLICATION

Priority is claimed on Japanese Patent Application No. 2025-034388, filed Mar. 5, 2025, the content of which is incorporated herein by reference.

### BACKGROUND

### Field of the Invention

The present invention relates to a vehicle control device, a vehicle control method, and a non-transitory storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on preventive safety technology such as driving support of supporting a driver’s driving. For example, a vehicle braking control device that decelerates and stops a vehicle on the basis of an obstacle detected by an obstacle detecting means is known (Japanese Unexamined Patent Application, First Publication No. 2016-124389).

### SUMMARY

In the vehicle braking control device according to the related art, deceleration control may not be appropriately performed. For example, a detection range for an obstacle is limited, and thus an obstacle detected before approaching the obstacle may no longer be detected (an obstacle be lost) when a vehicle approaches the obstacle. For example, when a distance between a vehicle and an obstacle is equal to or less than 2 m, the obstacle may enter a dead angle of an obstacle detecting means (for example, a camera) and the obstacle may become undetectable. When the obstacle is lost as described, maintenance or release of deceleration control may not be appropriately performed.

In order to solve the aforementioned problem, an objective of the present invention is to provide a vehicle control device, a vehicle control method, and a non-transitory storage medium that can appropriately perform deceleration control when loss of an object occurs. More specifically, an objective thereof is to appropriately perform deceleration control on an object which becomes undetectable because a vehicle and the object approach. Another objective thereof is to contribute to advancement of a sustainable transportation system.

A vehicle control device, a vehicle control method, and a non-transitory storage medium or program according to the present invention employ the following configurations.

(1) According to an aspect of the present invention, there is provided a vehicle control device including: a storage medium storing computer-readable instructions; and one or more processors connected to the storage medium, the one or more processors executing the computer-readable instructions to: recognize an object near a vehicle on the basis of surroundings information indicating a surrounding situation of the vehicle, the surrounding situation being provided by a detection device to detect the surrounding situation at intervals of a predetermined detection period; perform deceleration control for decelerating the vehicle with respect to the object when a degree of approach between the vehicle and the object satisfies predetermined conditions on the basis of a result of the recognition; and continuously perform the deceleration control even when the object is not temporarily recognized while performing the deceleration control.

(2) In the aspect of (1), the one or more processors execute the computer-readable instructions to continuously perform the deceleration control when the object is in a detected state continuously for a predetermined time or longer or for a predetermined detection period or longer before the detected state changes to a non-detected state , wherein the detected state is a state in which the object is detected by the detection device, and the non-detected state is a state in which the object is not detected by the detection device.

(3) In the aspect of (1) or (2), the one or more processors execute the computer-readable instructions to: recognize the object near the vehicle on the basis of a surrounding image captured by the detection device; and continuously perform the deceleration control when the object located in a lower part of the surrounding image becomes undetectable.

(4) In the aspect of (3), the one or more processors execute the computer-readable instructions to: recognize the object in the plurality of surrounding images captured by the detection device over time in a time series, each the plurality of surrounding images being captured at a predetermined timing and being compatible the surrounding image; and continuously perform the deceleration control when an undetectable area is enlarged from bottom to top as the object moves from top to bottom in each the plurality of surrounding images in continuous display of the plurality of surrounding images, the undetectable area being an area of the object outside of an imaging range of the surrounding image.

(5) In the aspect of (4), the size of the undetectable area increases in proportion to an amount of movement in a traveling direction of the vehicle.

(6) In the aspect of any one of (1) to (5), the detection device includes an imaging device configured to capture the surrounding image and an ultrasonic sensor, and the one or more processors execute the computer-readable instructions to: recognize the object near the vehicle on the basis of one or both of first information and second information, the first information being the surrounding image, the second information being information associated with reflected waves of ultrasonic waves emitted from the detection device; perform first deceleration control when the object has been recognized on the basis of the first information; perform second deceleration control in which an upper limit of deceleration is less than the upper limit of the first deceleration control when the object has been recognized on the basis of the second information; and increase the upper limit of the deceleration of the second deceleration control when the second deceleration control is performed while the first deceleration control is being performed.

(7) In the aspect of (6), he imaging device is provided at a position located in the vehicle above the ultrasonic sensor and the position being not able to be imaged of a downward area in a predetermined distance from the imaging device, and the ultrasonic sensor is provided at a position being detectable of the object located in the downward area.

(8) According to another aspect of the present invention, there is provided a vehicle control method that is performed by a computer, the vehicle control method including: recognizing an object near a vehicle on the basis of surroundings information indicating a surrounding situation of the vehicle, the surrounding situation being provided by a detection device to detect the surrounding situation at intervals of a predetermined detection period; performing deceleration control for decelerating the vehicle with respect to the object when a degree of approach between the vehicle and the object satisfies predetermined conditions on the basis of a result of the recognition; and continuously performing the deceleration control even when the object is not temporarily detected by the detection device and the object is not recognized while performing the deceleration control.

(9) According to another aspect of the present invention, there is provided a non-transitory storage medium storing a program for causing a computer to perform: recognizing an object near a vehicle on the basis of surroundings information indicating a surrounding situation of the vehicle, the surrounding situation being provided by a detection device to detect the surrounding situation at intervals of a predetermined detection period; performing deceleration control for decelerating the vehicle with respect to the object when a degree of approach between the vehicle and the object satisfies predetermined conditions on the basis of a result of the recognition; and continuously performing the deceleration control even when the object is not temporarily detected by the detection device and the object is not recognized while performing the deceleration control.

With the vehicle control device, the vehicle control method, and the non-transitory storage medium according to the aspects of (1) to (9), it is possible to appropriately perform deceleration control when an object has been lost by continuously performing deceleration control even when the detection device does not temporarily detect the object and the recognizer does not recognize the object.

According to the aspect of (2), it is possible to more appropriately determine whether to continuously perform deceleration control by continuously performing the deceleration control on the basis of the premise that the object is in the detected state continuously for a predetermined time before the detected state changes to the non-detected state.

According to the aspect of (3), it is possible to more appropriately determine whether to continuously perform deceleration control by continuously performing the deceleration control on the basis of the premise that an object located in a lower part of a surrounding image becomes undetectable.

According to the aspect of (4), it is possible to more appropriately determine whether to continuously perform deceleration control by continuously performing the deceleration control on the basis of the premise that an object included in a surrounding image captured at a predetermined timing moves from top to bottom in surrounding images in a time series subsequent to the predetermined timing.

According to the aspect of (5), it is possible to more appropriately determine whether to continuously perform deceleration control by continuously performing the deceleration control on the basis of the premise that an undetectable area is enlarged in proportion to an amount of movement in the traveling direction of the vehicle.

According to the aspect of (6), it is possible to perform deceleration control with appropriate intensity by extending the upper limit of deceleration of the second deceleration control when the second deceleration control is performed while the first deceleration control is being performed.

According to the aspect of (7), by installing an ultrasonic sensor at a position at which an object located at a position which cannot be imaged by the imaging device is detectable, it is possible to detect an object again through further approach between the vehicle and the object even when the object is located at a non-imaging position and becomes temporarily undetectable due to approach between the vehicle and the object.

### BRIEF DESCRIPTION OF THE DRAWINGS

FIG. 1 is a diagram showing a configuration of a vehicle system employing a vehicle control system according to an embodiment.

FIG. 2 is a diagram showing an example of a situation to which processing according to the embodiment is applied.

FIG. 3 is a diagram showing an example of a situation to which processing according to the embodiment is applied at each time point.

FIG. 4 is a flowchart showing an example of a process flow that is performed by a driving support device.

FIG. 5 is a diagram showing an example of a surrounding image.

FIG. 6 is a diagram showing an example of a surrounding image at each time point.

FIG. 7 is a diagram showing an example of a situation to which the processing according to the embodiment is applied at each time point.

FIG. 8 is a flowchart showing an example of a process flow that is performed by the driving support device.

FIG. 9 is a diagram showing an example of a correlation between deceleration for each of first deceleration control and second deceleration control and a distance from a vehicle to an object.

FIG. 10 is a diagram showing an example of a situation to which the processing according to the embodiment is applied at each time point.

### DESCRIPTION OF EMBODIMENTS

### Entire configuration

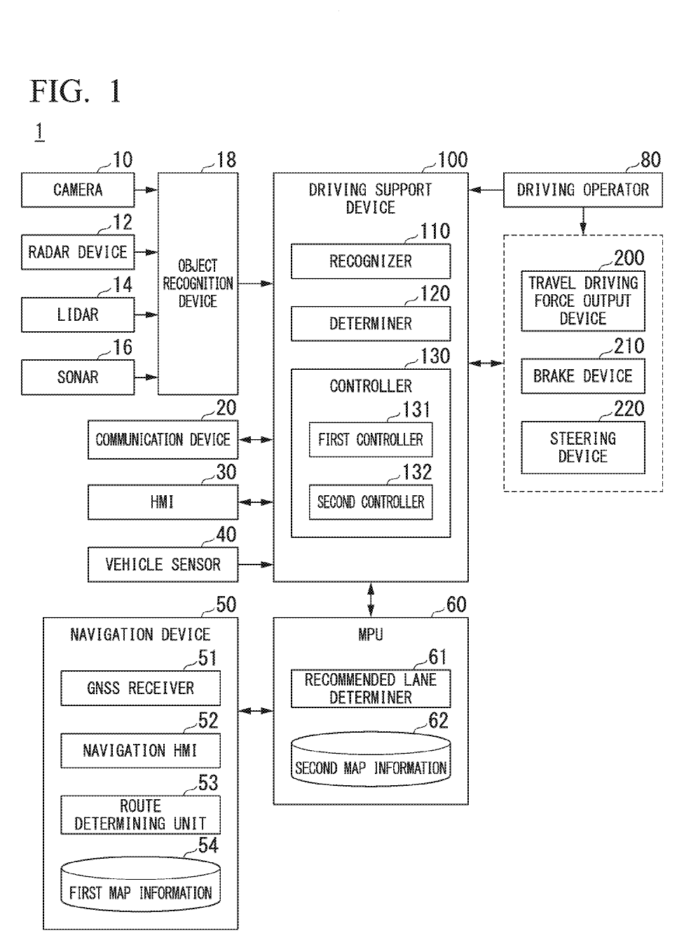

FIG. 1 is a diagram showing a configuration of a vehicle system 1 employing a vehicle control system according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell. In the present embodiment, it is assumed that the present invention is applied to a vehicle with four wheels, but the present invention may be applied to another vehicle other than the vehicle.

The vehicle system 1 includes, for example, a camera 10, a radar device 12, a Light Detection and Ranging (LIDAR) device 14, a sonar 16, an object recognition device 18, a communication device 20, a human-machine interface (HMI) 30, a vehicle sensor 40, a navigation device 50, a map positioning unit (MPU) 60, an operator 80, a driving support device 100, a travel driving force output device 200, a brake device 210, a steering device 220. These devices or instruments are connected to each other via a multiplex communication line such as a controller area network (CAN) communication line, a serial communication line, a radio communication network, or the like. The configuration shown in FIG. 1 is only an example, and a part of the configuration may be omitted or another configuration may be added thereto. The driving support device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on the vehicle (hereinafter referred to as a vehicle M) in which the vehicle system 1 is mounted. When a front view of the vehicle M is imaged, the camera 10 is attached to an upper part of a front windshield, a rear surface of a rearview mirror, or the like. The camera 10 images the surroundings of the vehicle M, for example, periodically and repeatedly. The camera 10 may be a stereoscopic camera. The camera 10 is an example of an “imaging device.”

The radar device 12 detects at least a position (a distance and a direction) of an object by radiating radio waves such as millimeter waves to the surroundings of the vehicle M and detecting radio waves (reflected waves) reflected by the object. The radar device 12 is attached to an arbitrary position on the vehicle M. The radar device 12 may detect a position and a speed of an object using a frequency modulated continuous wave (FM-CW) method. The radar device 12 is also attached to, for example, front corners (left and right corners) of the vehicle M. Accordingly, the radar device 12 can detect an object which is crossing the front of the vehicle M.

The LIDAR device 14 radiates light (or electromagnetic waves of wavelengths close to light) to the surroundings of the vehicle M and measures scattered light. The LIDAR device 14 detects a distance to an object on the basis of a time period from radiation of light to reception of light. The radiated light is, for example, a pulse-like laser beam. The LIDAR device 14 is attached to an arbitrary position on the vehicle M.

The sonar 16 radiates ultrasonic waves to the surroundings of the vehicle M and measures reflected waves. The sonar 16 detects a distance to an object on the basis of a time period from radiation of ultrasonic waves to reception of reflected waves. The sonar 16 is attached to an arbitrary position of the vehicle M. When an object in front of the vehicle M is detected, the sonar 16 is installed in a front bumper or the like of the vehicle M. A plurality of sonars 16 may be installed. The sonar 16 is an example of an “ultrasonic sensor.”

The object recognition device 18 performs a sensor fusion process on results of detection from some or all of the camera 10, the radar device 12, the LIDAR device 14, and the sonar 16 and recognizes a position, a type, a speed, and the like of an object. The object recognition device 18 outputs the result of recognition to the driving support device 100. The object recognition device 18 may output the results of detection from the camera 10, the radar device 12, the LIDAR device 14, and the sonar 16 to the driving support device 100 without any change. The object recognition device 18 may be omitted from the vehicle system 1.

The communication device 20 communicates with other vehicles near the vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the vehicle M and receives an input operation from the occupant. The HMI 30 includes, for example, various types of display devices, a speaker, a buzzer, a touch panel, a switch, and keys. The HMI 30 includes a display device. The display device is, for example, a display device which is provided at the center of an instrument panel of the vehicle M and which displays various types of information of the vehicle M, a so-called multi-information display, such as a speed meter (a speedometer) representing a traveling speed of the vehicle M or a rotation speed meter (a tachometer) representing the number of revolutions (a rotation speed) of the internal combustion engine of the vehicle M.

The vehicle sensor 40 includes a vehicle speed sensor that detects a speed of the vehicle M, an acceleration sensor that detects acceleration, a yaw rate sensor that detects an angular velocity around a vertical axis, a direction sensor that detects a direction of the vehicle M, and a sensor that detects a rotation angle of a steering wheel.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or complemented by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides a route on a map provided from the navigation device 50 into a plurality of blocks (for example, every 100 [m] in a vehicle traveling direction) and determines a recommended lane for each block with reference to the second map information 62. The recommended lane determiner 61 determines on which lane from the leftmost the vehicle is to travel. For example, when there is a branching point in the route on a map, the recommended lane determiner 61 determines the recommended lane such that the vehicle M can travel along a rational route for traveling to a branching destination. For example, when the vehicle M reaches a predetermined distance before the branching road, the recommended lane determiner 61 determines a lane connected to the branching road as a recommended lane. The recommended lane determiner 61 and the second map information 62 may be a functional unit or information included in another device such as the driving support device 100. For example, information of the recommended lane is provided to a driver via the HMI.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, and phone number information. The second map information 62 may be updated from time to time by causing the communication device 20 to communicate with another device.

The operator 80 includes, for example, a steering wheel, an accelerator pedal, a brake pedal, a shift lever, and other operators. A sensor that detects an amount of operation or whether an operation has been performed is attached to the operator 80, and results of detection of the sensor are output to the driving support device 100 or output to some or all of the travel driving force output device 200, the brake device 210, and the steering device 220. The steering wheel may not have to have a ring shape and may have a shape such as a deformed steering wheel, a joystick, or a button.

The driving support device 100 includes, for example, a recognizer 110, a determiner 120, and a controller 130. The recognizer 110, the determiner 120, and the controller 130 are realized, for example, by causing a hardware processor such as a central processing unit (CPU) to execute a program (software). Some or all of such constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the removable storage medium (a non-transitory storage medium) into a drive device. The controller 130 or a functional unit including the determiner 120 and the controller 130 is an example of a “controller.”

The recognizer 110 recognizes a state such as a position, acceleration, or a speed of an object near the vehicle M on the basis of surrounding information input from a detection device that detects a surrounding situation of the vehicle M at intervals of a predetermined detection period via the object recognition device 18. The detection period is determined according to a type, specifications, or the like of the detection device. The detection device includes, for example, some or all of the camera 10, the radar device 12, the LIDAR device 14, and the sonar 16. When a plurality of detection devices are included in the vehicle system 1, the recognizer 110 recognizes an object near the vehicle M on the basis of some or all of surrounding information provided from the plurality of detection devices. For example, a position of an object is recognized as a position in an absolute coordinate system with an origin set to a representative point of the vehicle M (such as the center of gravity or the center of a drive shaft) and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof.

The recognizer 110 recognizes, for example, a lane of the vehicle M or another nearby lane. The lane is a lane (a traveling lane) in which the vehicle M is traveling or an oncoming lane with respect to the traveling lane. For example, the recognizer 110 recognizes the traveling lane by comparing a pattern of road marking lines acquired from the second map information 62 (for example, a pattern of solid lines and dotted lines) with a pattern of road marking lines near the vehicle M recognized from an image captured by the camera 10. In addition to the lane marking lines, the recognizer 110 may recognize the traveling lane by recognizing the lane marking lines or traveling lane boundaries (road boundaries) including edges of roadsides, curbstones, median strips, guard rails, and the like. In this recognition, the position of the vehicle M acquired from the navigation device 50 or the processing result from the INS may be considered. The recognizer 110 recognizes, stop lines, obstacles, red signals, toll gates, and other road events near the vehicle M.

The recognizer 110 recognizes behavior of the vehicle M on the basis of the results of detection from the vehicle sensor 40. For example, the recognizer 110 recognizes a position or a posture of the vehicle M with respect to the traveling lane at the time of recognition of the traveling lane. The recognizer 110 may recognize, for example, a degree of separation of a reference point of the vehicle M from the lane center and an angle of the traveling direction of the vehicle M with respect to a line formed by connecting the lane centers as the relative position and the relative posture of the vehicle M with respect to the traveling lane. Instead, the recognizer 110 may recognize a position of a reference point of the vehicle M with respect to one side line of the traveling lane (a road marking line or a road boundary) as the relative position of the vehicle M with respect to the traveling lane.

The determiner 120 determines whether a degree of approach between the vehicle M and an object near the vehicle M satisfies predetermined conditions on the basis of the result of recognition from the recognizer 110. Specifically, when the recognizer 110 recognizes an object near the vehicle M, the determiner 120 calculates a degree of approach between the vehicle M and the object and determines whether the calculated degree of approach satisfies the predetermined conditions. The degree of approach is a degree at which the vehicle M and the object approach. The degree of approach may be calculated, for example, on the basis of a distance between the vehicle M and the object or may be calculated on the basis of a time to collision until the vehicle M and the object come into contact. The predetermined conditions may be, for example, that “the distance between the vehicle M and an object OB is less than a predetermined value” or may be that the “time to collision of the vehicle M with the object B is less than a predetermined time.” The predetermined conditions are not particularly limited as long as the predetermined conditions uses a degree of approach between the vehicle M and the object OB.

When an object recognized to be present near the vehicle M is not present any more on the basis of the result of recognition from the recognizer 110, the determiner 120 determines whether the object has been lost. An “object has been lost” means a state in which an object detected in the traveling direction of the vehicle M is not detected due to approach between the vehicle M and the object. That is, the determiner 120 determines that an object has been lost when an object located in the traveling direction of the vehicle M has not been recognized by the recognizer 110 due to approach between the vehicle M and the object. The determination of “whether the object has been lost” will be described later.

The controller 130 controls the whole constituents included in the driving support device 100 and the vehicle system 1. For example, the controller 130 controls steering of the vehicle M, controls the speed of the vehicle M, or controls the HMI 30 such that information is provided to a driver. The controller 130 includes a first controller 131 and a second controller 132.

The first controller 131 controls the vehicle M according to the determination result based on surroundings information (hereinafter referred to as first information) detected by the camera 10. Specifically, when the determiner 120 determines that the degree of approach between an object recognized to exist near the vehicle M and the vehicle M satisfies a predetermined condition (when the degree of approach is equal to or greater than a first predetermined degree) on the basis of the first information, the first controller 131 performs control based on the degree of approach between the vehicle M and the object. For example, the first controller 131 performs control for curbing the degree of approach between the vehicle M and the object. The control for curbing the degree of approach is, for example, speed adjustment support and warning. The speed adjustment support is control for adjusting the speed of the vehicle M. The speed adjustment support may be, for example, deceleration control which is control for decreasing the traveling speed of the vehicle M or control for stopping the vehicle M. Deceleration control that is performed by the first controller 131 is referred to as first deceleration control. The warning is for attracting the driver’s attention. The warning may be, for example, display of a warning image, outputting of warning sound, or vibration of the steering wheel. For example, as the warning, a stronger warning may be performed as the likelihood of approach becomes higher. For example, when the degree of approach is not curbed after a warning image has been displayed, the warning may be performed using sound in addition to an image. The first controller 131 performs so-called collision mitigation brake system (CMBS) control. The first information may include surroundings information detected by the radar device 12.

The second controller 132 controls the vehicle M according to the determination result based on surroundings information (hereinafter referred to as second information) detected by the sonar 16. Specifically, when the determiner 120 determines that the degree of approach between an object recognized to exist near the vehicle M and the vehicle M satisfies a predetermined condition (when the degree of approach is equal to or greater than a second predetermined degree) on the basis of the second information, the second controller 132 performs control based on the degree of approach between the vehicle M and the object. For example, when the degree of approach between the vehicle M and the object is equal to or greater than a predetermined value, the second controller 132 performs control for curbing the degree of approach between the vehicle M and the object. The control for curbing the degree of approach is, for example, speed adjustment support and warning. The speed adjustment support is control for adjusting the speed of the vehicle M. The speed adjustment support may be, for example, deceleration control which is control for decreasing the traveling speed of the vehicle M or control for stopping the vehicle M. Deceleration control that is performed by the second controller 132 is referred to as second deceleration control. The second deceleration control is deceleration control in which an upper limit of deceleration is less than that of the first deceleration control. The warning is for attracting the driver’s attention. The warning may be, for example, display of a warning image, outputting of warning sound, or vibration of the steering wheel. For example, as the warning, a stronger warning may be performed as the likelihood of approach becomes higher. When a plurality of sonars 16 are provided, a position at which the sonar 16 with an increased degree of approach is installed may be included in display of a warning image. For example, when the degree of approach is not curbed after the warning image has been displayed, the warning may be performed using sound in addition to an image. The second controller 132 provides a function of a so-called parking sensor system.

When the determiner 120 determines that an object has been lost while the first deceleration control is being performed, the first controller 131 may continuously perform the first deceleration control (details of which will be described later).

The travel driving force output device 200 outputs a travel driving force (a torque) for allowing the vehicle M to travel to driving wheels. The travel driving force output device 200 includes, for example, a combination of an internal combustion engine, an electric motor, and a transmission and an electronic control unit (ECU) that controls them. The ECU controls the constituents on the basis of information input from the driving support device 100 or information input from the operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the driving support device 100 or the information input from the operator 80 such that a brake torque based on a braking operation is output to vehicle wheels.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the operator 80 to change the direction of the turning wheels.

### Processing details

In the present embodiment, the controller 130 performs deceleration control when an object is detected in the traveling direction of the vehicle M and continuously performs the deceleration control when the detection device does not temporarily detect the object and the recognizer 110 does not recognize the object while performing the deceleration control. For example, when an object detected in the traveling direction of the vehicle M has become undetectable, avoidance of approach to the object which has been lost is supported by causing the controller 130 to continuously perform the deceleration control when loss of an object satisfying following conditions has occurred.

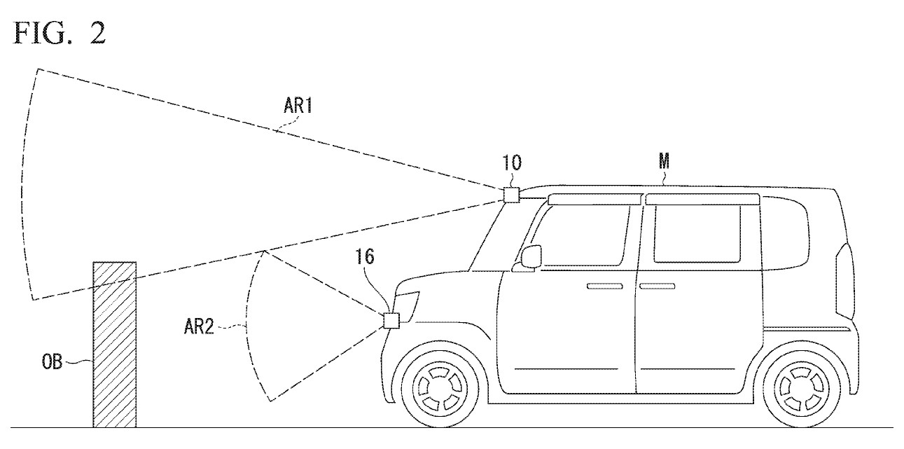

FIG. 2 is a diagram showing an example of a situation to which processing according to the embodiment is applied. In FIG. 2, an object OB is placed in the traveling direction (in front) of a vehicle M. The vehicle M includes a camera 10 in an upper part thereof and includes a sonar 16 below the camera 10. In the example shown in FIG. 2, it is assumed that the camera 10 is provided at a height in the vicinity of a rearview mirror of the vehicle M, and the sonar 16 is provided in the vicinity of a bumper. The camera 10 captures an image associated with surroundings information (hereinafter referred to as a surrounding image P) included in a detection range (an imaging range) AR1. The detection range AR1 does not include a downward area in a predetermined distance from the camera 10. This area is a dead angle of the camera 10. The sonar 16 detects an object included in a detection range AR2. The sonar 16 is installed at a position at which an object in an area serving as the dead angle of the camera 10 can be detected. In the following description, a state in which the object OB is included in the detection range AR1 or the detection range AR2, that is, a state in which the object OB is detected by the detection device (the camera 10 or the sonar 16), is referred to as a detected state. A state in which the object OB is not included in the detection range AR1 and the detection range AR2, that is, a state in which the object OB is not detected by the detection device (the camera 10 or the sonar 16), is referred to as a non-detected state.

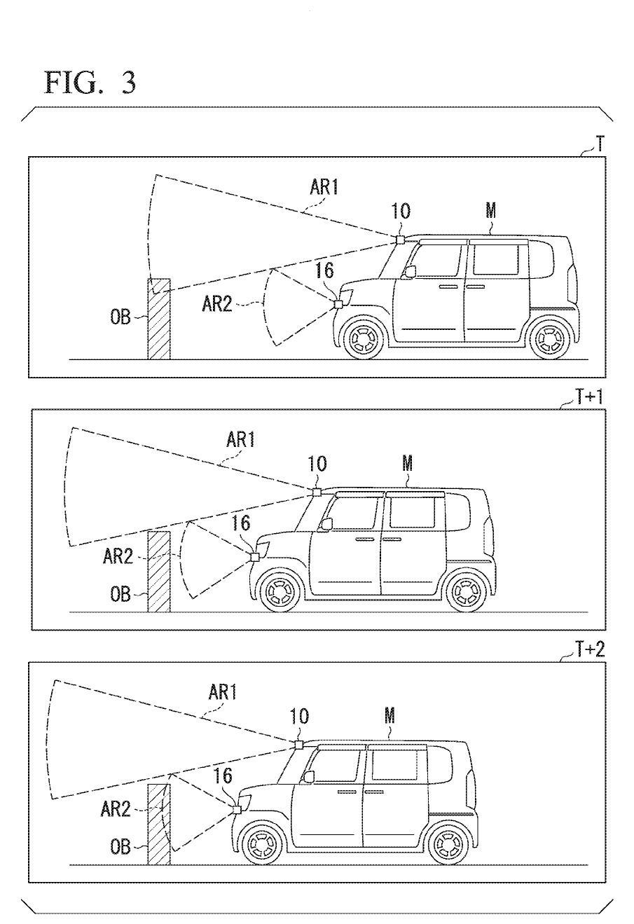

FIG. 3 is a diagram showing an example of a situation to which processing according to the embodiment is applied at each time point. FIG. 3 shows a situation in which the processing according to the present embodiment is applied at time T, time T+1, and time T+2. In a period of times T to T+2, the vehicle M moves ahead. At time T, the object OB is included in the detection range AR1. That is, at time T, the object OB is in the detected state. At this time, the recognizer 110 recognizes that the object OB is present in the traveling direction of the vehicle M on the basis of the detection result from the camera 10. When the object OB is present in the traveling direction of the vehicle M, the determiner 120 determines whether a degree of approach between the vehicle M and the object OB satisfies a predetermined condition. At time T, since the degree of approach between the vehicle M and the object OB satisfies the predetermined condition (equal to or greater than a first degree of approach), the first controller 131 performs the first deceleration control. At time T+1, a distance between the vehicle M and the object OB is shorter in comparison with at time T. At time T+1, the object OB is not included in the detection range AR1 and the detection range AR2. That is, at time T+1, the object OB is in the non-detected state. At this time, the object OB is not recognized by the recognizer 110. When the object OB is not recognized by the recognizer 110, the determiner 120 determines whether or not the object OB has been lost. At time T+1, since the object OB has been lost, the first controller 131 continuously performs the first deceleration control. For example, the first controller 131 continuously performs the first deceleration control such that approach of the vehicle M to the object OB is curbed on the basis of a position of the object recognized before the object has been lost. At time T+2, the distance between the vehicle M and the object OB is shorter in comparison with at time T+1. At time T+2, the object OB is not included in the detection range AR1 and is included in the detection range AR2. That is, at time T+2, the object OB is in the detected state. At this time, the object OB is recognized to be present in the traveling direction of the vehicle M by the recognizer 110. When the object OB is present in the traveling direction of the vehicle M, the determiner 120 determines whether the degree of approach between the vehicle M and the object OB satisfies a predetermined condition. At time T+2, since the degree of approach between the vehicle M and the object OB satisfies the predetermined condition (equal to or greater than a second degree of approach), the second controller 132 performs the second deceleration control.

In this way, by continuously performing the deceleration control when the detection device does not temporarily detect an object and the recognizer 110 does not recognize the object, it is possible to appropriately perform the deceleration control even when the object has been lost. Specifically, when an object OB is present in the traveling direction of the vehicle M, the object OB is first detected by the camera 10. When the vehicle M moves ahead and the vehicle M and the object OB approach, the object OB is located outside (at the dead angle) of the detection range AR1 of the camera 10 and thus is not detected by the camera 10 and the sonar 16. When the vehicle M additionally moves ahead and the vehicle M and the object OB approach more, the object OB is detected by the sonar 16. In this way, since the first controller 131 continuously performs the first deceleration control when the object OB is not temporarily detected by the detection device and is not recognized by the recognizer 110, it is possible to avoid ending of the first deceleration control before the second deceleration control is performed. By avoiding ending of the first deceleration control before the second deceleration control is performed, it is possible to appropriately support avoidance of approach between the vehicle M and the object OB.

The first controller 131 may perform the first deceleration control using another sensor (a first sensor) such as a radar device instead of the camera 10. The second controller 132 may perform the second deceleration control using another sensor (a second sensor) such as a camera or a radar device instead of the sonar 16. For example, the first sensor has only to be a sensor that can detect the detection range AR1, and the second sensor has only to be a sensor that can detect the detection range AR2.

### First flowchart

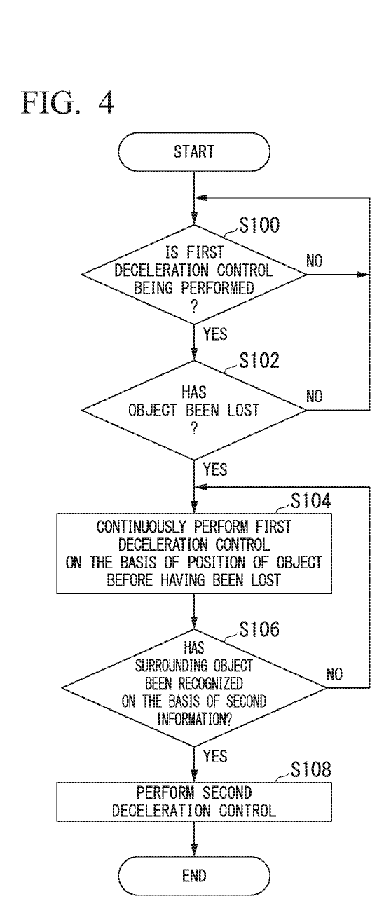

FIG. 4 is a flowchart showing an example of a process flow that is performed by the driving support device 100. The flowchart shown in FIG. 4 is performed, for example, when the vehicle M is traveling.

First, it is determined whether the first controller 131 is performing the first deceleration control (Step S100). When the first controller 131 is performing the first deceleration controller (Step S100: YES), the determiner 120 determines whether an object has been lost (Step S102). When an object has been lost (Step S102: YES), the first controller 131 continuously performs the first deceleration control on the basis of a position of the object recognized before the object has been lost (Step S104). On the other hand, when the first controller 131 is not performing the first deceleration control (Step S100: NO) or when an object has not been lost (Step S102: NO), the process flow returns to Step S100.

When the recognizer 110 recognizes a nearby object on the basis of the second information after the process of Step S104 has been performed (Step S106: YES), the second controller 132 performs the second deceleration control (Step S108). On the other hand, when the recognizer 110 does not recognize a nearby object on the basis of the second information after the process of Step S104 has been performed (Step S106: NO), the process flow returns to Step S104. After the process of Step S108 has been performed, the driving support device 100 ends the process flow shown in FIG. 4.

### Continuation condition (determination of “loss of object”)

A plurality of continuation conditions will be described below in detail. The continuation conditions are conditions used for the determiner 120 to determine whether an object has been lost. The determiner 120 determines that an object has been lost when the object is in the non-detected state and it is determined that all the conditions included in the continuation conditions have been satisfied and determines that an object has not been lost when one or more conditions included in the continuation conditions have not been satisfied.

Five continuation conditions including first to fifth conditions will be described. The first condition is a condition in which the distance between the vehicle M and the object OB recognized by the recognizer 110 immediately before the object OB enters the non-detected state is equal to or less than a predetermine set distance. The set distance is a value which is set on the basis of a range of a dead angle of the camera 10. The set distance may be changed, for example, on the basis of a type of the vehicle M, an installation position of the camera 10, a distance between the camera 10 and the traveling lane of the vehicle M, or the like. When the distance between the vehicle M and the object OB recognized by the recognizer 110 immediately before the object OB enters the non-detected state is equal to or less than the set distance, the determiner 120 determines that the first condition has been satisfied. When the distance between the vehicle M and the object OB recognized by the recognizer 110 immediately before the object OB enters the non-detected state is greater than the set distance, the determiner 120 determines that the first condition has not been satisfied.

The second condition is a condition in which the detected state is maintained for a predetermined time or longer or for a predetermined detection period or longer before the detected state is changed to the non-detected state. In other words, the second condition is a condition in which the object OB is continuously recognized by the recognizer 110 in the predetermined time or longer or in the predetermined detection period or longer before the object OB enters the non-detected state. When the object OB is continuously recognized by the recognizer 110 in the predetermined time or longer or in the predetermined detection period or longer before the object OB enters the non-detected state, the determiner 120 determines that the second condition has been satisfied. When the object OB is not continuously recognized by the recognizer 110 in the predetermined time or longer or in the predetermined detection period or longer before the object OB enters the non-detected state, the determiner 120 determines that the second condition has not been satisfied.

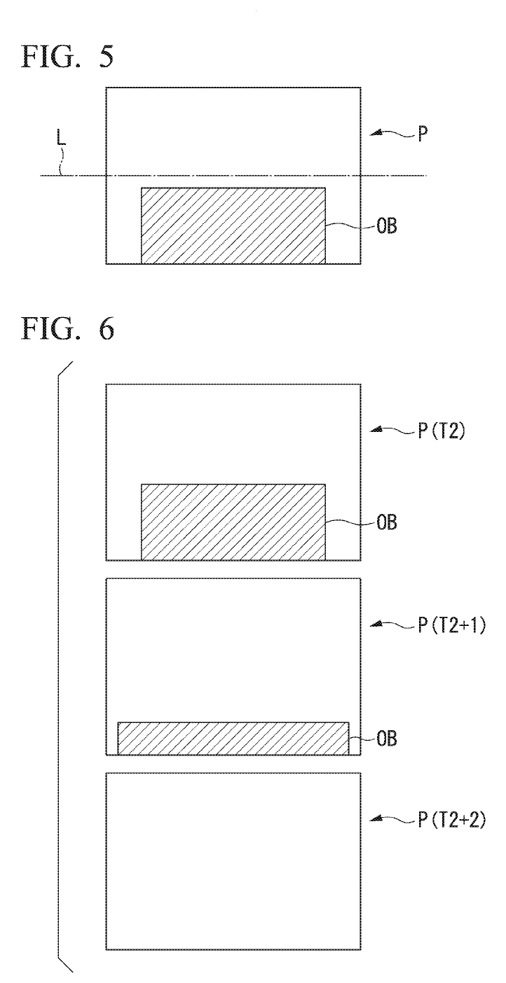

The third condition is a condition in which an object OB located in a lower part of a surrounding image has not been detected. In other words, the third condition is a condition in which an object OB located in the lower part of the surrounding image has been recognized by the recognizer 110 before the object OB enters the non-detected state. The surrounding image is an image including the surroundings of the vehicle M captured by the camera 10. FIG. 5 is a diagram showing an example of a surrounding image. A surrounding image P shown in FIG. 5 includes an object OB. In FIG. 5, the object OB is located in the lower part of the surrounding image P. “Located in the lower part of the surrounding image P” means that the object OB has only to be located below a reference position L of the surrounding image P. The reference position L may be set in advance. The reference position L may be, for example, the center of the surrounding image P. The reference position L may be set, for example, on the basis of the speed of the vehicle M or the magnitude of the dead angle of the camera 10. When an object OB located in the lower part of the surrounding image has been recognized by the recognizer 110 before the object OB enters the non-detected state, the determiner 120 determines that the third condition has been satisfied. When an object OB located in the lower part of the surrounding image has not been recognized by the recognizer 110 before the object OB enters the non-detected state, the determiner 120 determines that the third condition has not been satisfied.

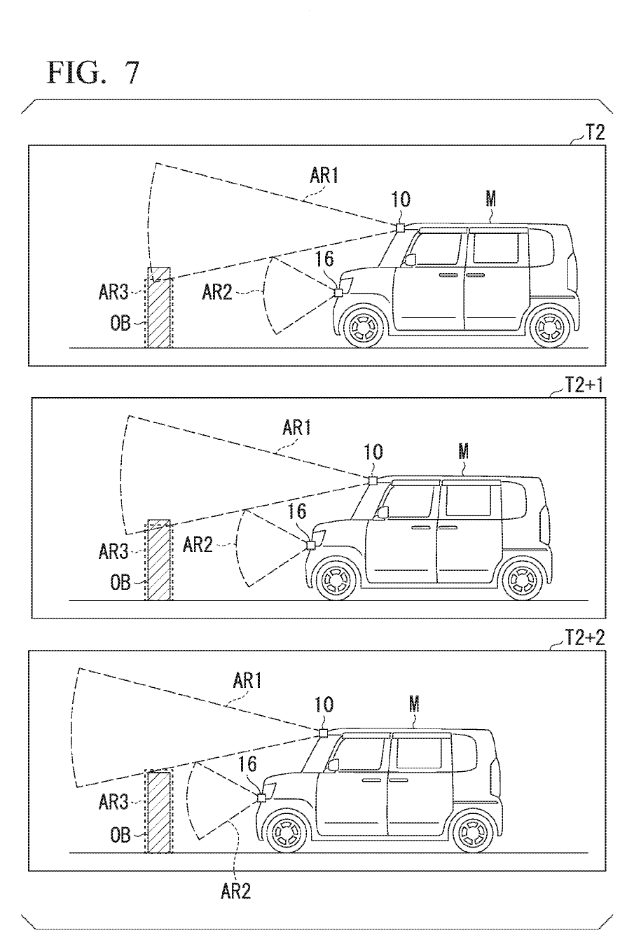

The fourth condition is a condition in which an undetectable area AR3 (see FIG. 7) outside of the imaging range of the surrounding image is enlarged from bottom to top as the object OB included in the surrounding image P captured at a predetermined timing moves from top to bottom in the surrounding images P in a time series after the predetermined timing before the object OB enters the non-detected state. The undetectable area AR3 is an area of the object OB not included in the surrounding image P, that is, the undetectable area AR3 is an area of the object OB outside the detection range AR1. For example, the determiner 120 identifies the size of the undetectable area AR3 based on the position and size of the object OB recognized by the recognizer 110 and based on the speed of the vehicle M.

FIG. 6 is a diagram showing an example of the surrounding image at each time points.FIG. 6 shows the surrounding images P captured by the camera 10 at time T2, time T2+1, and time T2+2. At time T2, the object OB is located in the lower part of the surrounding image P. At time T2+1 at which the vehicle M approaches the object OB, the object OB is located lower in the surrounding image P in comparison with at time T2. At time T2+2 at which the vehicle M further approaches the object OB, the object OB is not included in the surrounding image P. That is, in a period of times T2 to T2+2, the object OB included in the surrounding image P moves from top to bottom. FIG. 7 is a diagram showing an example of a situation in which the processing according to the present embodiment is applied at each time point. FIG. 7 shows a situation in which the processing according to the present embodiment is applied at time T2, time T2+1, and time T2+2. In the period of times T2 to T2+2, the object OB includes the undetectable area AR3. In the period of times T2 to T2+2, the vehicle M moves ahead. At time T2, a part of the object OB is included in the detection range AR1. The lower part of the object OB is the undetectable area AR3. At time T2+1, the vehicle M further approaches the object OB in comparison with at time T2. At this time, the undetectable area AR3 is enlarged from bottom to top in comparison with at time T2 as the vehicle M approaches the object OB. Specifically, the length in the height direction of the undetectable area AR3 increases in comparison with at time T2. At time T2 and time T2+1, the object OB is in the detected state. At time T2+2, the vehicle M further approaches the object OB in comparison with at time T2+1. At this time, the object OB is not included in the detection range AR1. That is, the undetectable area AR3 is further enlarged from bottom to top in comparison with at time T2+1. At time T2+2, the whole object OB is included in the undetectable area AR3. At time T2+2, the object OB is in the non-detected state.

The determiner 120 recognizes the object OB in the plurality of surrounding images P captured by the detection device over time in a time series, each the plurality of surrounding images P being captured at a predetermined timing and being compatible the surrounding image P. When the object OB moves from top to bottom in each the plurality of surrounding images P in continuous display of the plurality of surrounding images P before the object OB enters the non-detected state, that is, when the undetectable area AR3 is enlarged from bottom to top, the determiner 120 determines that the fourth condition has been satisfied. When the object OB included in the surrounding image P captured at a predetermined timing does not move from top to bottom in the surrounding images P in a time series after the predetermined timing before the object OB enters the non-detected state, that is, when the undetectable area AR3 is not enlarged from bottom to top, the determiner 120 determines that the fourth condition has not been satisfied.

The fifth condition is a condition in which the size of the undetectable area AR3 increases in proportion to an amount of movement in the traveling direction of the vehicle M before the object OB enters the non-detected state. The amount of movement may be a moving distance or a moving time. The amount of movement has only to be a value indicating an amount associated with movement of the vehicle M. When the size of the undetectable area AR3 increases in proportion to the amount of movement in the traveling direction of the vehicle M before the object OB enters the non-detected state, the determiner 120 determines that the fifth condition has been satisfied. When the size of the undetectable area AR3 does not increase in proportion to the amount of movement in the traveling direction of the vehicle M before the object OB enters the non-detected state, the determiner 120 determines that the fifth condition has not been satisfied.

The continuation conditions have only to include some or all of the first to fifth conditions. For example, the continuation conditions may include only the first condition or may include the first condition and the second condition. The conditions included in the continuation conditions may be changed on the basis of the type of the vehicle M, the position of the camera 10, or the like.

In this way, by continuously performing the first deceleration control when the determiner 120 determines that all the conditions included in the continuation conditions have been satisfied, it is possible to more appropriately perform deceleration control even when an object has been lost. Specifically, since the continuation conditions of the first deceleration control include the first condition, it is possible to continuously perform the first deceleration control for an object present at a distance at which there is a high likelihood that the object will be in the non-detected state and to appropriately support avoidance of approach between the vehicle M and the object. Since the continuation conditions of the first deceleration control include the second condition, it is possible to prevent the first deceleration control from being continuously performed for an erroneously detected object which is not actually present. Since the continuation conditions of the first deceleration control include the third condition, it is possible to continuously perform the first deceleration control for an object present at a position at which there is a high likelihood that the object will be in the non-detected state. Since the continuation conditions of the first deceleration control include the fourth condition or the fifth condition, it is possible to continuously perform the first deceleration control for an object of which the area not included in the surrounding image P is gradually enlarged, that is, an object with a high likelihood that the object will be actually present which is located at the dead angle of the camera 10 due to approach of the vehicle M to the object and to appropriately support avoidance of approach between the vehicle M and the object.

### Second flowchart

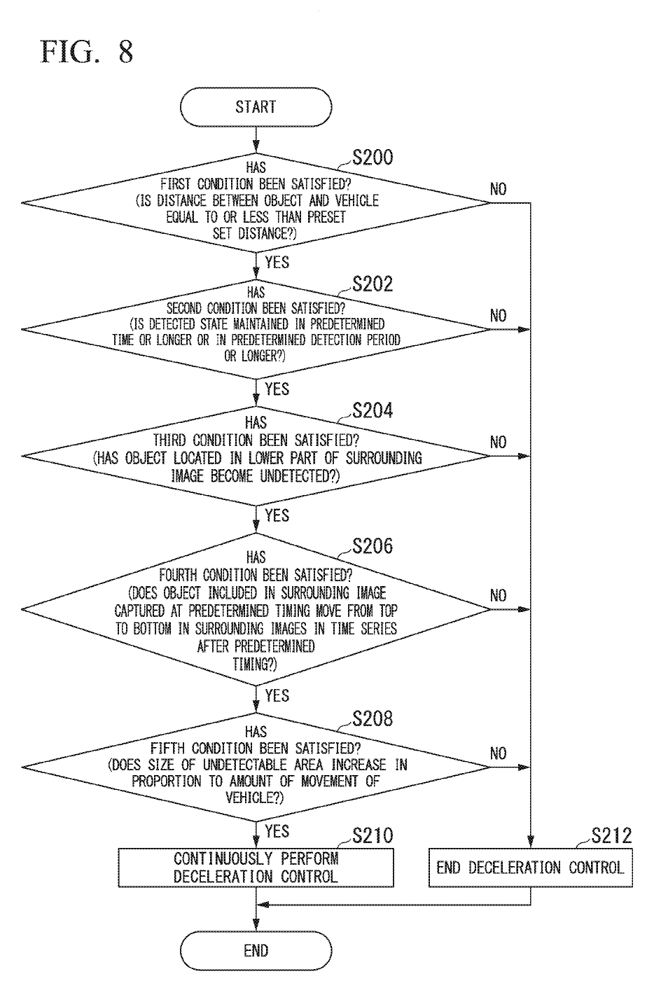

FIG. 8 is a flowchart showing an example of a process flow that is performed by the driving support device 100. The process of the flowchart shown in FIG. 8 may be performed instead of the process of Step S102 in the first flowchart.

First, the determiner 120 determines whether the first condition has been satisfied (Step S200). That is, the determiner 120 determines whether the distance between the vehicle M and the object OB recognized by the recognizer 110 immediately before the object OB enters the non-detected state is equal to or less than a preset distance. When the first condition has been satisfied (Step S200: YES), the determiner 120 determines whether the second condition has been satisfied (Step S202). That is, the determiner 120 determines whether the object OB has been continuously recognized for a predetermined time or longer or for a predetermined detection period or longer by the recognizer 110 before the object OB enters the non-detected state. When the second condition has been satisfied (Step S202: YES), the determiner 120 determines whether the third condition has been satisfied (Step S204). That is, the determiner 120 determines whether the object OB located in the lower part of the surrounding image has been recognized by the recognizer 110 before the object OB enters in the non-detected state. When the third condition has been satisfied (Step S204: YES), the determiner 120 determines whether the fourth condition has been satisfied (Step S206). That is, the determiner 120 determines whether the object OB included in the surrounding image P captured at a predetermined timing moves from top to bottom in the surrounding images P in a time series after the predetermined timing and the undetectable area AR3 is enlarged from bottom to top before the object OB enters the non-detected state. When the fourth condition has been satisfied (Step S206: YES), the determiner 120 determines whether the fifth condition has been satisfied (Step S208). That is, the determiner 120 determines whether the size of the undetectable area AR3 increases in proportion to the amount of movement in the traveling direction of the vehicle M before the object OB enters the non-detected state. When the fifth condition has been satisfied (Step S208: YES), the first controller 131 continuously performs the first deceleration control (Step S210). When the conditions have not been satisfied in Steps S200 to S208 (Steps S200 to S208: NO), the first controller 131 ends the first deceleration control (Step S212). After the process of Step S210 has been performed or after the process of Step S212 has been performed, the driving support device 100 ends the process flow illustrated in FIG. 8.

The order of the processes may be changed. For example, the process of Step S200 may be performed after the process of Step S202.

When the second controller 132 performs the second deceleration control while the first controller 131 is performing the first deceleration control, the upper limit of the deceleration in the second deceleration control may be increased. The increased upper limit in the second deceleration control may be, for example, equal to the upper limit in the first deceleration control.

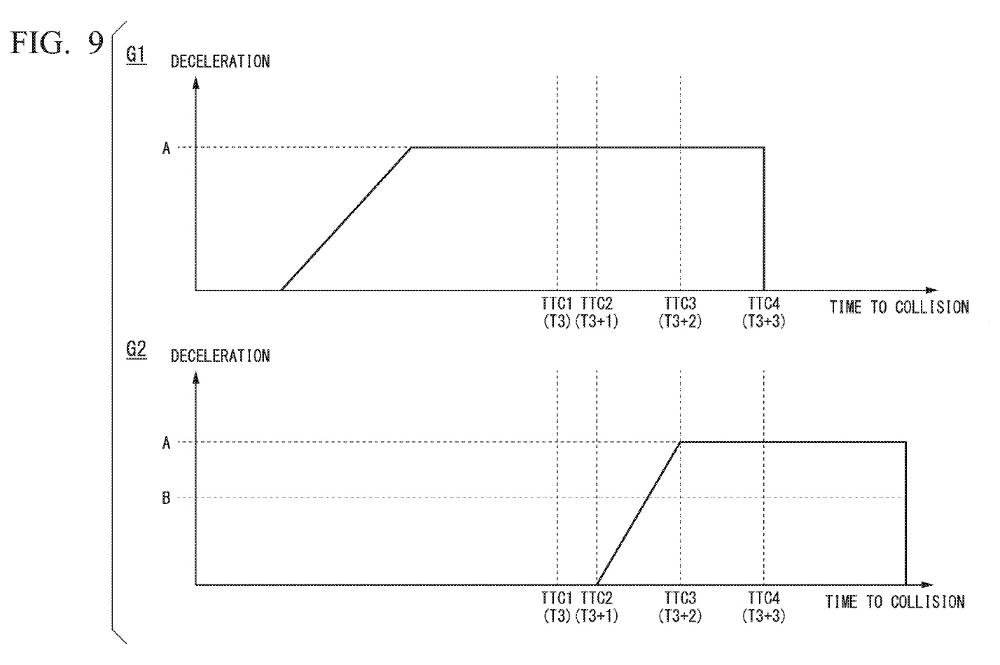

FIG. 9 is a diagram showing an example of a correlation of the time to collision with the deceleration in each of the first deceleration control and the second deceleration control. FIG. 9 includes a graph G1 which is a graph showing a correlation of the time to collision with the deceleration in the first deceleration control and a graph G2 which is a graph showing a correlation of the time to collision with the deceleration in the second deceleration control. In the graph G1 and the graph G2, the vertical axis represents the deceleration, and the horizontal axis represents the time to collision. The upper side of the vertical axis is defined as a plus side, and the deceleration increases toward the upper side. The right side of the horizontal axis is defined as a minus direction, and the time to collision decrease to the right side.

The magnitude of the deceleration based on the time to collision in the graph G1 will be described. The upper limit of the deceleration in the first deceleration control is an upper limit A. The deceleration increases in proportion to the time to collision until the time to collision becomes less than a first reference value (not illustrated) after the first deceleration control has been started by the first controller 131. That is, when the time to collision is equal to or greater than the first reference value, the deceleration increases as the time to collision decreases. The first reference value is a time longer than a preset time to collision TTC1. When the time to collision is the first reference value, the deceleration is the upper limit A. When the time to collision is equal to or less than the first reference value and equal to or greater than a time to collision TTC4, the deceleration is maintained at the upper limit A. When the time to collision is less than the time to collision TTC4, the deceleration is zero, and thus the first deceleration control is not performed. In other words, the first deceleration control is continuously performed until the time to collision TTC4 which is the time to collision at the time at which the vehicle M reaches a preset operation target position. The operation target position is a position at which continuation of the first deceleration control for the object OB ends. The operation target position may be set on the basis of the distance between the vehicle M and the object OB recognized by the recognizer 110 immediately before the object OB has been lost, the time to collision, or the like or may be set on the basis of the length of the detection range AR2 in the traveling direction of the vehicle M. The operation target position is, for example, a position in a predetermined distance (for example, several meters) before the object OB. The operation target position may be set, for example, on the basis of the type of the vehicle M, the installation position of the camera 10, the distance between the camera 10 and the traveling lane of the vehicle M, or the like. The operation target position has only to be a distance with which the time to collision is less than a time to collision TTC3 which is the time to collision in which the deceleration of the second deceleration control which will be described later is the upper limit.

The magnitude of the deceleration based on the time to collision in the graph G2 will be described. The upper limit of the deceleration in the second deceleration control except the situation in which the first deceleration control is switched to the second deceleration control is an upper limit B. However, when the second deceleration control is performed while the first deceleration control is being performed, the upper limit of the deceleration in the second deceleration control is increased to the upper limit A. In the graph G2, a correlation between the time to collision and the deceleration in the second deceleration control when the second deceleration control is performed while the first deceleration control is being performed is shown. When the time to collision is a time to collision TTC2, the second deceleration control is started by the second controller 132. The deceleration increases in proportion to the time to collision until the time to collision is less than the time to collision TTC2 and equal to or greater than the time to collision TTC3. That is, when the time to collision is equal to or greater than the time to collision TTC3, the deceleration increases as the time to collision decreases. When the time to collision is the time to collision TTC3, the upper limit of the deceleration is the upper limit A. When the time to collision is equal to or less than the time to collision TTC3 and equal to or greater than a second reference value (not illustrated), the deceleration is maintained at the upper limit A. The second reference value is a time shorter than the preset time to collision TTC4. The second reference value may be set, for example, on the basis of the type of the vehicle M, the installation position of the sonar 16, or the like. When the time to collision is less than the second reference value, the deceleration is zero. That is, when the time to collision is less than the second reference value, the second deceleration control is not performed. The second reference value may not be set. In this case, the second deceleration control is continuously performed in the state in which the deceleration is the upper limit A until the vehicle M stops.

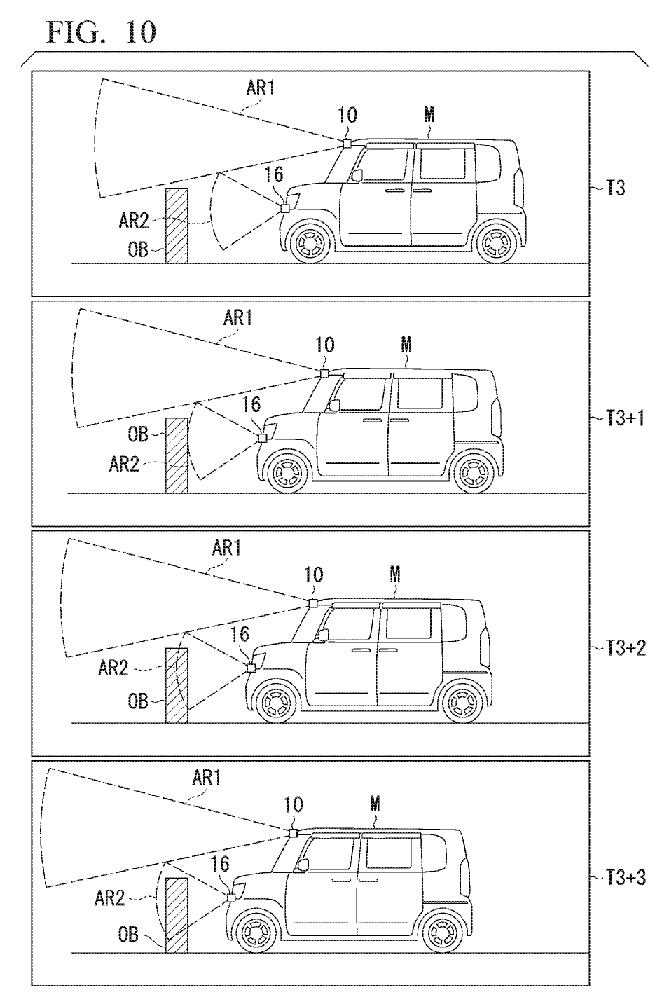

The time to collision TTC1, the time to collision TTC2, the time to collision TTC3, and the time to collision TTC4 in the graph G1 and the graph G2 are the same as the time to collision of the vehicle M with the object OB at time T3, time T3+1, time T3+2, and time T3+3 in FIG. 10 which will be described later.

FIG. 10 is a diagram showing an example of a situation to which the processing according to the present embodiment is applied at each time point. FIG. 10 illustrates the situation to which the processing according to the present embodiment is applied at time T3, time T3+1, time T3+2, and time T3+3. At time T3, the vehicle M moves ahead. At this time, the object OB is not included in the detection range AR1 and the detection range AR2. That is, at time T3, the object OB is in the non-detected state. At this time, the object OB is not recognized by the recognizer 110. At a timing before time T3, the object OB is included in the detection range AR1, and thus the determiner 120 determines that the object OB has been lost at time T3. At this time, since the first deceleration control is being performed, the first controller 131 continuously performs the first deceleration control with the deceleration of the upper limit A. At time T3, the time to collision is the time to collision TTC1. At time T3+1, the object OB is included in the detection range AR2. That is, at time T3+1, the object OB is in the detected state. At this time, the object OB is recognized to be present in the traveling direction of the vehicle M by the recognizer 110. When the object OB is present in the traveling direction of the vehicle M, the determiner 120 determines whether the degree of approach between the vehicle M and the object OB satisfies a predetermined condition. At time T3+1, since the degree of approach between the vehicle M and the object OB satisfies the predetermined condition, the second controller 132 starts the second deceleration control. At this time, the deceleration in the second deceleration control is not the upper limit. The first controller 131 is performing the first deceleration control (see FIG. 9). At time T3+1, the time to collision is the time to collision TTC2. At time T3+2, the object OB is included in the detection range AR2. At this time, the same process as at time T3+1 is performed by the driving support device 100, and the second controller 132 performs the second deceleration control with the deceleration of the upper limit A (see FIG. 9). Similarly to at time T3+2, the first controller 131 is performing the first deceleration control. At time T3+2, the time to collision is the time to collision TTC3. At time T3+3, the object OB is included in the detection range AR2. At this time, the same process as at time T3+1 and time T3+2 is performed by the driving support device 100, and the second controller 132 performs the second deceleration control with the deceleration of the upper limit A. At time T3+3, since the time to collision is the time to collision TTC4, the first controller 131 ends the first deceleration control (see FIG. 9).

In this way, by increasing the upper limit of the deceleration in the second deceleration control when the second controller 132 performs the second deceleration control while the first controller 131 is performing the first deceleration control, it is possible to perform deceleration control with an appropriate intensity even when the vehicle M and the object OB approach further. Specifically, when the object OB has been lost and the first deceleration control is being performed, the object OB is detected by the sonar 16 due to approach of the vehicle M to the object OB. Since the object OB has been detected, the object OB is recognized by the recognizer 110, and the second deceleration control is performed by the second controller 132. At this time, since the first deceleration control is being performed, the upper limit in the second deceleration control is increased. Since the operation target position of the first deceleration control is a time shorter than the time to collision TTC3 in which the deceleration in the second deceleration control is the upper limit, continuation of the first deceleration control ends after the deceleration in the second deceleration control has become the upper limit. At this time, since the upper limit in the second deceleration control matches the upper limit in the first deceleration control, the controller 130 can perform the deceleration control without decreasing the deceleration even after the first deceleration control has been ended and switched to the second deceleration control, and it is possible to appropriately decelerate and stop the vehicle M.

The above-mentioned embodiment can be expressed as follows:
An information processing device including
a storage medium that stores computer-readable instructions, and
a processor connected to the storage medium,
wherein the processor execute the computer-readable instructions to: recognize an object near a vehicle on the basis of surroundings information indicating a surrounding situation of the vehicle, the surrounding situation being provided by a detection device to detect the surrounding situation at intervals of a predetermined detection period;
   perform deceleration control for decelerating the vehicle with respect to the object
      when a degree of approach between the vehicle and the object satisfies predetermined conditions on the basis of a result of the recognition; and
   continuously perform the deceleration control
      even when the object is not temporarily recognized while performing the deceleration control.

While exemplary embodiments of the present invention have been described above, the present invention is not limited to the embodiments and can have various modifications and substitutions applied thereto without departing from the gist of the present invention.

What is claimed is:

1. A vehicle control device comprising:
a storage medium storing computer-readable instructions; and
one or more processors connected to the storage medium,
the one or more processors executing the computer-readable instructions to:
recognize an object near a vehicle on the basis of surroundings information indicating a surrounding situation of the vehicle, the surrounding situation being provided by a detection device to detect the surrounding situation at intervals of a predetermined detection period;
perform deceleration control for decelerating the vehicle with respect to the object
when a degree of approach between the vehicle and the object satisfies predetermined conditions on the basis of a result of the recognition; and
continuously perform the deceleration control
even when the object is not temporarily recognized while performing the deceleration control.

2. The vehicle control device according to claim 1, wherein the one or more processors execute the computer-readable instructions to
continuously perform the deceleration control
when the object is in a detected state continuously for a predetermined time or longer or for a predetermined detection period or longer before the detected state changes to a non-detected state , and wherein
the detected state is a state in which the object is detected by the detection device, and
the non-detected state is a state in which the object is not detected by the detection device.

3. The vehicle control device according to claim 1, wherein the one or more processors execute the computer-readable instructions to:
recognize the object near the vehicle on the basis of a surrounding image captured by the detection device; and
continuously perform the deceleration control
when the object located in a lower part of the surrounding image becomes undetectable.

4. The vehicle control device according to claim 3, wherein the one or more processors execute the computer-readable instructions to:
recognize the object in the plurality of surrounding images captured by the detection device over time in a time series, the plurality of surrounding images each of which is captured at a predetermined timing and compatible the surrounding image; and
continuously perform the deceleration control
when an undetectable area is enlarged from bottom to top as the object moves from top to bottom in the plurality of surrounding images in continuous display of the plurality of surrounding images, the undetectable area being an area of the object outside of an imaging range of the surrounding image.

5. The vehicle control device according to claim 4, wherein
the size of the undetectable area increases in proportion to an amount of movement in a traveling direction of the vehicle.

6. The vehicle control device according to claim 3, wherein
the detection device includes an imaging device configured to capture the surrounding image and an ultrasonic sensor, and
wherein the one or more processors execute the computer-readable instructions to:
recognize the object near the vehicle on the basis of one or both of first information and second information, the first information being the surrounding image, the second information being information associated with reflected waves of ultrasonic waves emitted from the detection device;
perform first deceleration control
when the object has been recognized on the basis of the first information;
perform second deceleration control in which an upper limit of deceleration is less than the upper limit of the first deceleration control
when the object has been recognized on the basis of the second information; and
increase the upper limit of the deceleration of the second deceleration control
when the second deceleration control is performed while the first deceleration control is being performed.

7. The vehicle control device according to claim 6, wherein
the imaging device is provided at a position located in the vehicle above the ultrasonic sensor and the position being not able to be imaged of a downward area in a predetermined distance from the imaging device, and
wherein the ultrasonic sensor is provided at a position being detectable of the object located in the downward area.

8. A vehicle control method that is performed by a computer, the vehicle control method comprising:
recognizing an object near a vehicle on the basis of surroundings information indicating a surrounding situation of the vehicle , the surrounding situation being provided by a detection device to detect the surrounding situation at intervals of a predetermined detection period;
performing deceleration control for decelerating the vehicle with respect to the object when a degree of approach between the vehicle and the object satisfies predetermined conditions on the basis of a result of the recognition; and
continuously performing the deceleration control even when the object is not temporarily detected by the detection device and the object is not recognized while performing the deceleration control.

9. A non-transitory storage medium storing a program for causing a computer to perform:
recognizing an object near a vehicle on the basis of surroundings information indicating a surrounding situation of the vehicle, the surrounding situation being provided by a detection device to detect the surrounding situation at intervals of a predetermined detection period;
performing deceleration control for decelerating the vehicle with respect to the object when a degree of approach between the vehicle and the object satisfies predetermined conditions on the basis of a result of the recognition; and
continuously performing the deceleration control even when the object is not temporarily detected by the detection device and the object is not recognized while performing the deceleration control.
